(19) United States
(12) Patent Application Publication
(10) Pub. No.: US 2007/0071090 A1
(43) Pub. Date: Mar. 29, 2007

(54) Method for performing context adaptive binary arithmetic coding with stochastic bit reshuffling for fine granularity scalability

(75) Inventors: Wen-Hsiao Peng, Emei Township (TW); Tihao Chiang, Taipei City (TW); Hsueh-Ming Hang, Hsinchu City (TW)

Correspondence Address: BUCKNAM AND ARCHER, 1077 NORTHERN BOULEVARD, ROSLYN, NY, 11576, US

(73) Assignee: National Chiao Tung University

(21) Appl. No.: 11/158,034

(22) Filed: Jun. 21, 2005

(51) Int. Cl. H04N 11/04

(52) U.S. Cl. 375/240.2

(57) ABSTRACT

The disclosure relates to a method for performing context based binary arithmetic coding with a stochastic bit-reshuffling scheme in order to improve MPEG-4 fine granularity scalability (FGS) based bit-plane coding. The method comprises steps of: replacing 8×8 DCT with 4×4 integer transform coefficient in MPEG-4 AVC (Advance Video-Coding); partitioning each transform coefficient into significant bit and refinement bit; setting up significant bit context based on energy distribution within a transform block and spatial correlation in adjacent blocks; using an estimated Laplacian distribution to derive coding probability for the refinement bit; and using the context across bit-planes to partition each significant bit-plane for saving side information bit.

### BACKGROUND OF THE INVENTION

1. Field of the Invention

The invention relates a method for performing context adaptive binary arithmetic coding with stochastic bit reshuffling for fine granularity scalability. More particularly, the invention relates to a method for performing context based binary arithmetic coding with a stochastic bit-reshuffling scheme in order to improve fine granularity scalability (FGS) based bit-plane coding.

2. Related Art of the Invention

Scalable video coding (SVC) has increasing importance with the rapidly growing of multimedia applications over Internet and wireless channels, in such applications, the video information may be transmitted over error-prone channels with fluctuated bandwidth and will be consumed through different networks to diverse devices. To serve multimedia applications under a heterogeneous environment, the MPEG-4 committee has developed the Fine Granularity Scalability (FGS), W. Li, “Overview of Fine Granularity Scalability in MPEG-4 standard,” IEEE Trans, Circuits Syst. Video Technol., vol. 11, no. 3,pp. 301-317, 2001, that provides a DCT-based scalable approach in a layer fashion. The base layer is coded by a non-scalable MPEG-4 advanced simple profile (ASP) while the enhancement layer is intra coded with embedded bit-plane coding to achieve fine granular scalability. Similar bit-plane coding scheme is also adopted in latest MPEG-4 Part 10 Amd. 1 Scalable Video Coding standard.

In current bit-plane coding, the enhancement-layer frame is first transformed with 8×8 DCT. To provide fine granular scalability, the transform coefficients are coded in a bit-plane by bit-plane manner. From the most significant bit-plane to the least significant bit-plane, the coding of DCT blocks is ordered in raster scanning. Each bit-plane of a DCT block is independently represented by <RUN, EOP> symbols and coded with Huffman tables. Current approach poses two problems:

a. Poor Coding Efficiency

The firs problem is poor coding efficiency. Such problem comes from three factors: The first is that bits carrying different weights of information are coded without differentiation. The second is that existing correlation across bit-planes and among spatially adjacent blocks is not exploited. Lastly, the Huffman coding can not efficiently match the change of statistic during the coding. In current approach, different weights of bits in a bit-plane are jointly grouped by (Run, EOP) symbols. Moreover, the coding of each bit-plane in a block is uncorrelated. Further, each transform block is independently coded. These issues together cause poor coding efficiency.

b. Poor Subjective Quality

The second problem is that the deterministic raster scan causes quality discrepancy when the enhancement-layer is partially decoded. Currently, in each bit-plance, MPEG-4 FGS performs the coding in a block-by-block manner. All the blocks are ordered in raster scanning. The coding of a block can only be preceded when the coding of previous one is completed. When the enhancement-layer is partially decoded, such order may only refine the upper part of a decoded frame with one extra bit-plane. The uneven refinement causes subjective quality degradation.

Some researches have proposed to improve the coding efficiency of DCT based bit-plane coding. The existing approaches, N. K. Laurance and D. M. Monro, “Embedded DCT Coding With Significance Masking”. IEEE Int'l Conference on Acoustics, Speech, and Signal Processing, 1997, and D. Nister and C. Christopoulos, “An Embedded DCT-Based Still Image Coding Algorithm”, IEEE Int'l Conference on Acoustics, Speech, and Signal Processing, 1998, have taken context based binary arithmetic coding for efficient DCT based bit-plane coding. N. K. Laurance et al. improve the coding efficiency by using the energy distribution of DCT transform. Additionally, D. Nister et al. further consider the spatial correlation existing in the co-located coefficients of the adjacent blocks during their context design. However, these prior works do not consider correlation across bit-planes. More coding efficiency improvement is possible. In addition, these prior works still use raster scan order in each bit-plane coding. The problem of uneven quality distribution is remained.

Further, the documentation of W. H. Peng, C. N. Wang. T. Chiang and H. M. Huang, “Context-based binary arithmetic coding with stochastic bit reshuffling for FGS”, IEEE Int'l Symposium on Circuit and System, Vancouver, May 2004, is the prior work of this application, however, the reshuffling scheme in this paper restricts the reordering within the same bit- plane.

Furthermore, there are several patents which disclose bit reshuffling scheme and coefficient reordering scheme for the improvement of coding efficiency, such as Y. Chen et al., “Fine granular scalable video with embedded DCT coding of the enhancement layer”, US patent document no., 2003/0133499; W. Li, “Scalable video coding method and apparatus”, U.S. Pat. No. 6,275,531; J. Li et al., “Embedded image coder with rate-distortion optimization”, U.S. Pat. No. 6,625,321; W. Lin et al., “Apparatus and method for performing bitplane coding with reordering in a fine granularity scalability coding system”, US patent document no., 2004/00177949; and Radha et al., “Bit-plane dependent signal compression”, U.S. Pat. No. 6,501,397. However, they perform 8×8 DCT before coding which requires complicated floating point operations, and their coding flows, which start from the MSB bit-plane to LSB bit-plane, do not consider the rate-distortion data update which is for content aware reshuffling.

Therefore, it is necessary to develop a method which can simplify the operation and allow more flexibility on bit coding order, so as to improve the coding efficiency of FGS based bit-plane coding.

### SUMMARY OF THE INVENTION

In view of the foregoing problems, the object of the invention is to provide a method for performing context adaptive binary arithmetic coding with stochastic bit reshuffling for fine granularity scalability, in order to improve both the coding efficiency and the subjective quality of FGS based bit-plane coding.

For achieving the object, according to the invention, there is provided a method for performing context adaptive binary arithmetic coding with stochastic bit reshuffling for fine granularity scalability, comprising steps of replacing 8×8 DCT with 4×4 integer transform coefficient in MPEG-4 AVC (Advanced VideoCoding, also known as H.264); partitioning each transform coefficient into significant bit and refinement bit; setting up significant bit context based on energy distribution within a transform block and spatial correlation in adjacent blocks; using an estimated Laplacian distribution to derive coding probability for the refinement bit; and using the context across bit-plane for saving side information bit.

Further, according to the above method of the invention, the step of using the context across bit-planes to partition each significant bit-plane for saving side information bit includes using EOSP location of higher bit-plane to partition each significant bit-plane into two parts for saving side information bit.

Still further, according to the above method of the invention, the method comprises the step of determining coding order of each bit by its estimated rate-distortion, wherein all the coding bits are ordered in a descending ordering in accordance with a ratio of estimated distortion reduction over estimated bit rate.

More further, according to the above method of the invention, the estimated rate-distortion for each bit is obtained by using discrete Laplacian distribution to model the transform coefficient.

Moreover, according to the above method of the invention, the method further comprises the steps of using binary entropy for coding bit rate estimation, and using maximum likelihood principle to provide an estimation for parameters of the Laplacian distribution.

In addition, according to the above method of the invention, the method further comprises the steps of using a dynamic coding flow for the stochastic bit reshuffling.

The foregoing and other objects, features and advantages of the invention will become more apparent from the detailed description of preferred embodiments of the invention, which proceeds with reference to the accompanying drawings.

### BRIEF DESCRIPTION OF THE DRAWINGS

FIG. 1 is a graph illustrating the definitions of most significant bit-planes and most significant bit;

FIG. 2 shows an example of significant bit-plane partition according to the invention;

FIG. 3 shows an example of content index for significant bit according to the invention;

FIG. 4 shows an example of discrete Laplacian distribution and the estimation of AD.;

FIG. 5 shows an overview of dynamic coding flow for stochastic rate-distortion optimization according to the invention;

FIG. 6 shows examples of including new bit in a transform block, respectively, the first 4 coding bits are: (a) Significant bit of DC coefficient at BP3, (b) Significant bit of AC i at BP3, (c) Refinement bit of AC1 at BP2 and (d) Significant bit of AC2 at BP3, according to the invention;

FIG. 7 shows an overview of dynamic memory organization for stochastic bit reshuffling according to the invention;

FIG. 8 shows PSNR (objective quality) comparison of (a) Foreman, (b) Tempete, (c) Mobile and (d) News, wherein the base-layer is with Qp=38, Frame rate=10 frames/s, Frame size=CIF (352×288); and

FIG. 9 shows subjective quality comparison with Foreman sequence, wherein the base-layer is with Qp=38, Frame rate=10 frames/s and the enhancement-layer is truncated at 384 kbits/s.

### DETAILED DESCRIPTION OF THE INVENTION

A. Terminologies

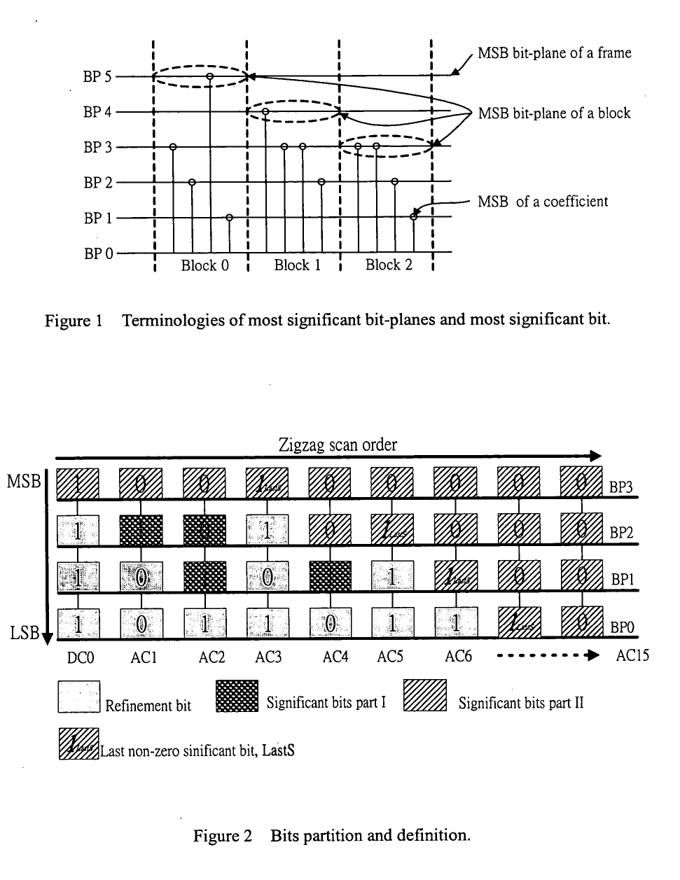

FIG. 1 defines our terminology when we refer to “MSB bit-plane of a frame”, “MSB bit-plane of a block” and “MSB of a coefficient”. For simplicity, we assume the entire enhancement-layer frame has 3 transform blocks and each block has 4 coefficients. The vertical axis shows the bin number of the transform coefficient. The MSB bit of a coefficient represents its most significant bit. The MSB bit-plane of a frame denotes the one that includes the MSB bit of the maximum coefficient in the entire frame. On the other hand, the MSB bit-plane of a block represents the one that includes the MSB bit of the maximum coefficient in a block.

B. Bit Classification and Bit-Plane Partition

The bits of each transform coefficient are partitioned into three types including significant bit, refinement bit and sign bit. From the MSB bit-plane to the LSB bit-plane of a block, the significant bits of a coefficient are those bits before (and include) its MSB bit. On the other hand, the refinement bits are those after the MSB. The sign bit represents the sign of a coefficient.

Additionally, for each bit-plane of a transform block, we proposed two side information symbols. They are End-Of-Significant-Bit-plane (EOSP) and Part_II_ALL_ZERO. The EOSP is coded after a non-zero significant bit to indicate about the end of significant bit coding in a bit-plane. To minimize the EOSP bits, we partition the significant bits of a bit-plane into two parts according to the position of last non-zero significant bit in previous bit-plane, named as LastS. The first part (Part I) refers to the group of significant bits before the LastS in a zigzag order and the second part (Part II) covers the rest of significant bits. FIG. 2 shows an example of our significant bit-plane partition. Each column of FIG. 2 denotes the binary representation of the transformed coefficients. From top to bottom, each row represents a bit-plane. For bit partition, the LastS of bit-plane 2 is at AC3. For bit-plane 2, the significant bits before AC3 are classified as part I and the remaining significant bits are classified as part II. In our algorithm, we save EOSP bit by transmitting the EOSP symbol after the non-zero significant bits in Part II.

As the last non-zero significant bit of current coding bit-plane actually happens before LastS, we need to transmit all the zero significant bits in Part II. To avoid coding these redundant bits, we use a Part_II_ALL_ZERO symbol to notify the decoder about the all zero case. Specifically, such symbol is transmitted before the Part II coding in each bit-plane.

TABLE 1
Procedure for calculating the context index of MSB REACHED symbol

```
//Summation of MSB REACHED status in the nearest four adjacent blocks
ContextIndex=
MSB_REACHED[UpperBlock]+MSB_REACHED[BottomBlock]+
MSB_REACHED[Left
Block]+MSB_REACHED[RightBlock]
//UpperLeft to BottomRight diagonal direction
IF (MSB_REACHED[UpperLeftBlock]=1 &&
MSB_REACHED[BottomRightBlock]=1)
    ContextIndex+=2*(MSB_REACHED[UpperLeftBlock]
                +MSB_REACHED[BottomRightBlock])
ELSE
    ContextIndex+=(MSB_REACHED[UpperLeftBlock]
                +MSB_REACHED[BottomRightBlock])
//UpperRight to BottomLeft diagonal direction
IF (MSB_REACHED[UpperRightBlock]=1 &&
MSB_REACHED[BottomLeftBlock]=1)
    ContextIndex+=2*(MSB_REACHED[UpperRightBlock]
                +MSB_REACHED[BottomLeftBlock])
ELSE
    ContextIndex+=(MSB_REACHED[UpperRightBlock]
                +MSB_REACHED[BottomLeftBlock])
//Truncation
IF (ContextIndex>=4)
    ContextIndex=4
```

TABLE 2
Context index of significant bit

| Index | Description | Range |
|---|---|---|
| Run | Distance between the coding bit and the | 0˜7 |
| | previous non-zero significant bit in | |
| | zigzag order. | |
| Weighted summation | The procedure is the same as Table 1 | 0˜4 |
| of significant status | except that we replace the MSB | |
| | REACHED with significant status of | |
| | the co-located coefficient. | |
| Frequency band | Zigzag index of coding bit. | 0˜10 |
| position | | |

C. Context Design
1. MSB_REACHED

MSB_REACHED symbol is a side information bit that indicates if the MSB bit-plane of a block is reached or not. For context index calculation of MSB_REACHED symbol, we refer to the MSB_REACHED status of the adjacent 9 blocks. Table 1 lists our detail procedure.

2. Significant Bit

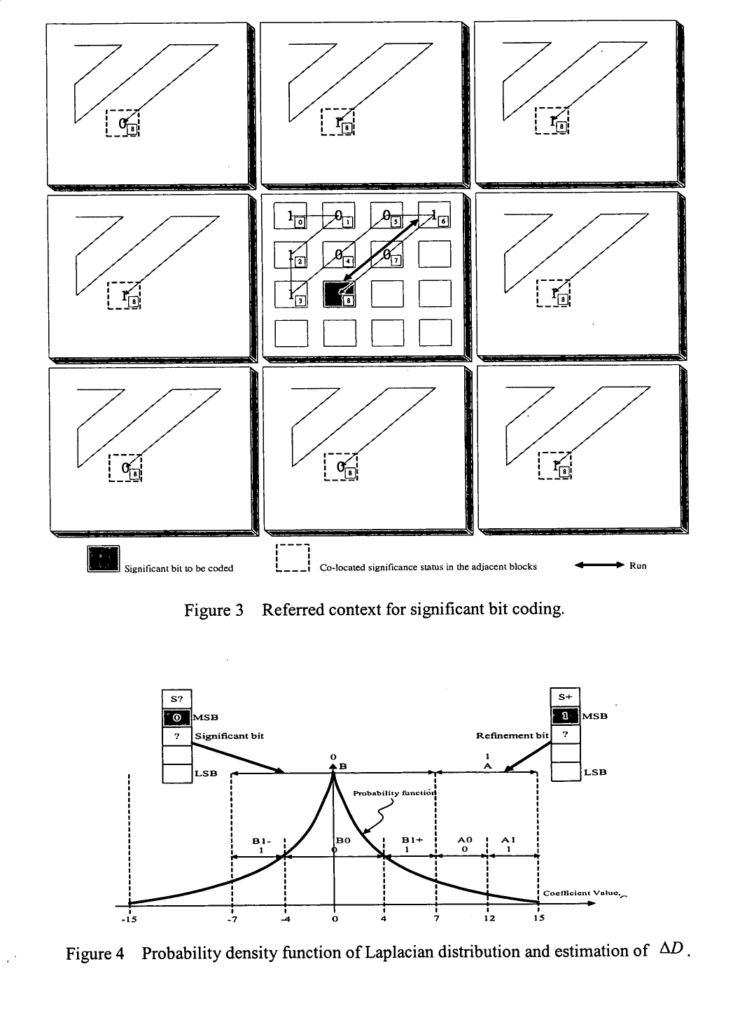

Table 2 lists our referred context for coding a significant bit. Particularly, for calculating the weighted summation index in Table 2, we replace the MSB_REACHED in Table 1 with the significant status of co-located coefficients and follow the same procedure in Table 1 for index calculation. In addition, to trade-off cost and performance, the value of each referred context index is truncated appropriately. FIG. 3 gives an example of our significant bit context model where the “Run” value is 1, the weighted summation of significance status is 4 and the frequency band position is 8.

3. Refinement Bit

We use the estimated Laplacian model to derive the coding probability for the refinement bit. No additional context models are created for refinement bit. As it will be shown later, the probability model for a refinement bit can be derived from the estimated Laplacian distribution.

4. Sign Bit

We use an equal probability model for sign bit coding.

TABLE 3
Context index of EOSP bit

| Index | Description | Range |
|---|---|---|
| EOSP offset | The offset between coding bit and | −7˜7 |
| | the predicted EOSP location in zigzag order. | |
| Bit-plane index of | From the MSB bit-plane to LSB | 0˜4 |
| a block | bit-plane of a block, the bit-plane index is | |
| | incremented by one from zero. | |

5. End-Of-Significant-Bit-Plane (EOSP)

Table 3 summarizes our referred context model for EOSP bit. First, we predict the EOSP location by taking the average of EOSP positions in the nearest 4 blocks. With the predicted location, we define the context for EOSP bit as the offset between current non-zero significant bit and the predicted EOSP location. Note that the offset could be a negative value. In addition, we incldue the bit-plane index as part of the referred context. From the MSB bit-plane to the LSB bit-plane of a block, the bit-plane index is incremented by one from zero. To save memory, the bit-plane index greater than 4 is truncated.

6. Part_II_ALL_Zero

We take the bit-plane index of a block as our context model for Part_II_ALL_zero symbol. From the MSB bit-plane to the LSB bit-plane of a block, the index is incremented by one from zero. To save memory, the bit-plane index greater than 4 is truncated.

TABLE 4
Proposed CABAC algorithm with raster scan coding order

```
Nblock: Number of total 4 × 4 blocks in a frame
DC0, AC1˜45: DC and AC coefficients in zigzag scan
MAIN:
FOR bit-plane=MSB to LSB of the entire frame
  FOR 4×4_Block_Index=1 to Nblock (Line 2)
    FOR Coeff_Index=DC0 to AC15 (Line 3)
      IF (MSB_REACHED[4×4_Block_lndex])
        IF (Coding Bit == Significant Bit)
          Encode/Decode_Significant/Sign/EOSP_Bit( )
      ELSE
        Encode/Decode_One_Refinement_Bit( )
  ELSE
      IF (Coeff_lndex==DC0)
        Encode/Decode_One MSB_REACHED_Bit( )
        IF (MSB_REACHED[4×4 Block Index])
          Encode/Decode Significant/Sign/EOSP_Bit( )
SubRoutine: Encode/Decode_Significant/Sign/EOSP_Bit( )
IF (Is Part II significant bit)
  IF (Is first Part II significant bit)
    Encode/Decode_Part_II_ALL_Zero_Bit( )
  IF (Part II not all zero)
    Encode/Decode_One_Significant_Bit( )
    IF (non-zero significant bit)
      Encode/Decode_One_Sign_Bit( )
      Encode/Decode_One_EOSP_Bit( )
ELSE
  Encode/Decode_One_Significant_Bit( )
  IF (non-zero significant bit)
    Encode/Decode_One_Sign_Bit( )
```

D. Coding Flow with Deterministic Raster Scan

Table 4 shows the pseudo code of our proposed bit-plane coding using the raster scan order. For each enhancement-layer frame, we start the bit-plane coding from the MSB to the LSB. For each bit-plane, the coding is performed in a block-by-block manner. Within each block, the coefficients are visited in zigzag order. Before the coding of each block, MSB_REACHED symbol is first coded to notify if current block has reached its MSB bit-plane. When MSB_REACHED is true, we initiate the bit-plane coding. During the coding, different bit types are coded differently. If the input bit being considered is a significant bit, we will examine the partition to which the current significant bit belongs. For significant bit in Part I, we simply code the significant bit together with a sign bit. For the significant bit in Part II, we additionally code an EOSP bit after the sign bit. Particularly, we will code a Part_II_ALL_Zero bit in the beginning of each part II significant bit coding. When Part_II_ALL_ZERO or EOSP is true, we will stop the coding of current block and proceed to next block. If the input bit is a refinement bit, we simply code the refinement bit itself. From the experiment results, we have found 0.5˜1dB PSNR improvement as compared to MPEG-4 FGS approach. More detail experiment results will be presented later.

E. Stochastic Bit Reshuffling

To improve the subjective quality, a stochastic bit reshuffling scheme was proposed. We perform the bit reshuffling in a stochastic rate-distortion sense. We assign each bit with two estimated factors that are: (1) squared error reduction, ΔD, and (2) coding cost, ΔR. The squared error reduction represents the contribution to the squared error improvement and the coding cost denotes the required bit rate. Given these two factors for each bit, Eq. (1) defines our coding order criterion where the notation Ê( ) denotes taking estimation, the superscript denotes the bit identification and the subscript index represents the coding order. In short, we reorder all the coding bits in a descending order according to the ratio of estimated ΔD over estimated ΔR.

$$\frac{\hat{E} ( Δ {D}_{1}^{i} )}{\hat{E} ( Δ {R}_{1}^{i} )} > \frac{\hat{E} ( Δ {D}_{2}^{j} )}{\hat{E} ( Δ {R}_{2}^{j} )} > \frac{\hat{E} ( Δ {D}_{3}^{k} )}{\hat{E} ( Δ {R}_{3}^{k} )} > … > \frac{\hat{E} ( Δ {D}_{N}^{1} )}{\hat{E} ( Δ {R}_{N}^{1} )} \qquad ( 1 )$$

F. Parameter Estimation

1. Discrete Laplacian distribution

To estimate ΔD and ΔR of each bit, we resort to their expectation values. For calculating expectation value, we need the probability distribution of transform coefficient. Since decoder does not have exact probability distribution, we adopt a model based approach to minimize the overhead for decoder. Specifically, we use the 4×4 integer transform in MPEG-4 AVC/H.264 at enhancement-layer. We model each 4×4 transform coefficient as a random variable with Laplacian distribution. Eq. (2) formulizes the probability model of discrete Laplacian distribution where Cₙ represents the n^{th} zigzag ordered coefficient, kₙ denotes its outcome and αₙ is the Laplacian parameter to be determined.

$$P ( {C}_{n} = {k}_{n} ) = \frac{1 - {α}_{n }}{1 + {α}_{n}} * {α}_{n}^{\vert {k}_{n} \vert} \qquad ( 2 )$$

2. Estimation of Laplacian parameter

Eq. (3) shows our maximum likelihood estimator for the Laplacian parameter. As shown, to estimate αₙ, we first calculate the mean of absolute value of the co-located coefficients at n^{th} zigzag position and then substitute it in Eq. (3). In our approach, the estimation is conducted at encoder and the estimated parameters are transmitted to decoder. With 4×4 integer transform, we simply require 16 parameters for the luminance component and another 16 parameters for the chrominance part.

$${α}_{n} = \frac{- \frac{1}{AvgK} + \sqrt{{( \frac{1}{AvgK} )}^{2} + 4}}{2} where AvgK = \frac{{\sum }_{j = 1}^{M} \vert {k}_{n}^{j} \vert}{M} \qquad ( 3 )$$

3. Estimation of ΔD

We estimate the ΔD of each coefficient bit by its reduction on the expected squared error. In FIG. 4, we show a predefined Laplacian distribution of a coefficient and give two examples for illustrating the ΔD estimation. At the left hand side, we show the example of significant bit where the MSB of the coefficient is coded as zero. At the right hand side, we show the case of refinement bit where the MSB of the coefficient is coded as non-zero.

From the coded MSB bit, we can tell the uncertainty interval in which the actual value is located. For the case of significant bit, we know the actual value is in the interval B after the MSB coding. Similarly, for the case of refinement bit, the actual value is located in the interval A. Given these intervals, the coding of each coefficient bit is to further reduce the uncertainty interval. For instance, in FIG. 4, the significant bit to be coded is to determine that the actual value is in the interval B1+, B0 or B1−. Similarly, the refinement bit to be coded is to decide that the actual value is in the interval A1 or A0.

The reduction of uncertainty interval represents the reduction of expected squared error. For each interval, we define the expected squared error as the variance in the interval. Thus, our ΔD estimation for each bit can be written as the reduction of variance. Eq. (4) defines our ΔD estimation, Ê( ), for the significant bit example in FIG. 4 where E(X|Y) represents the conditional expectation value of X given condition Y and P(X|Y) denotes the conditional probability. In Eq. (4), the first term represents the variance in the interval B and the three subtraction terms denote the weighted variance of interval B1+, B1− and B0 respectively. Since we cannot decide in which interval the actual value is located before the coding, the weighting fact of each subtraction term represents the probability of each subinterval. Following the same procedure, the AD estimation for all the other bits can be calculated. Eq. (5) defines the ΔD estimation for the refinement bit case in FIG. 4.

To make our significant bit reshuffling content aware, we replace the subinterval probabilities in Eq. (4) with the context probability models. Eq. (6) defines our content aware ΔD estimation for a significant bit. In Eq. (6), P_{ctx} ( ) denotes the associated context probability of a significant bit.

Since we do not develop any context model for refinement bit, for the ΔD estimation of a refinement bit, we follow Eq. (5).
Ê(ΔD) of significant bit≡
Ê(Cₙ²|CₙεB)
−P(CₙεB1+|CₙεB)*[E(Cₙ²|CₙεB1+)−E²(Cₙ|CₙεB1+)] (4)
−P(CₙεB1−|CₙεB)*[E(Cₙ²|CₙεB1−)−E²(Cₙ|CₙεB1−)]
−P(CₙεB0|CₙεB) *[E(Cₙ²|CₙεB0)]
Ê(ΔD) of refinement bit≡
[E(Cₙ²|CₙεA)−E²(Cₙ|CₙεA)] (5)
−P(CₙεA1|CₙεA)*[E(Cₙ²|CₙεA1)−E²(Cₙ|CₙεA1)]
−P(CₙεA0|CₙεA)*[E(Cₙ²|CₙεA0)−E²(Cₙ|CₙεA0)]
Improved Ê(ΔD) of significant bit≡
E(Cₙ²|CₙεB)
−P_{ctx}(1)*[E(Cₙ²|CₙεB1+)−E²(Cₙ|CₙεB1+)]
−P_{ctx}(0)*[E(Cₙ² |CₙεB0)] (6)
4. Estimation of ΔR

For estimating ΔR, we use binary entropy as defined in Eq. (7) where P(1) denotes the non-zero probability of an input bit.
H_{b}(P(1))≡−P(1)*log₂P(1)−(1−P(1))*log₂(1−P(1)) (7)

In Eq. (8) we show the ΔR estimation of a significant bit. The first term represents the binary entropy of a significant bit using the associated context probability model as argument while the second term denotes the estimated cost of a sign bit. In Eq. (8), we assume each sign bit averagely consumes one bit, Moreover, the cost of sign is weighted by the non-zero probability of significant bit. Specifically, the non-zero probability is derived from the associated context probability model.

In Eq. (9) we show the ΔR estimation of a refinement bit. Since there is no particular context probability model for refinement bit, we use the non-zero probability derived from Laplacian model for the binary entropy calculation. Specifically, the non-zero probability is the corresponding subinterval probability. For instance, in the refinement bit example of FIG. 4, the P_{model}(1) equals to P(A1|A).
Ê(ΔR) of significant bit≡H_{b}(P_{ctx}(1))+P_{ctx}(1)*1 (8)
Ê(ΔR) of refinement bit≡H_{b}(P_{model}(1)) (9)
G. Coding Flow of Stochastic Bit Reshuffling

For stochastic rate-distortion optimization, both encoder and decoder implement two dynamic coding lists to maintain the coding priority. One is for significant bit and the other is for refinement bit. Each bit in the list is allocated a register to record the bit location, bit type, coding context and estimated rate-distortion data.

In our algorithm, we pose two constraints on the coding order to avoid coding extra side information bits and redundant bits. These constraints are: (1) for each coefficient, the coding is conducted sequentially from MSB to LSB and (2) for each bit-plane of a transform block, the coding order of significant bits in part II always follows zigzag scan.

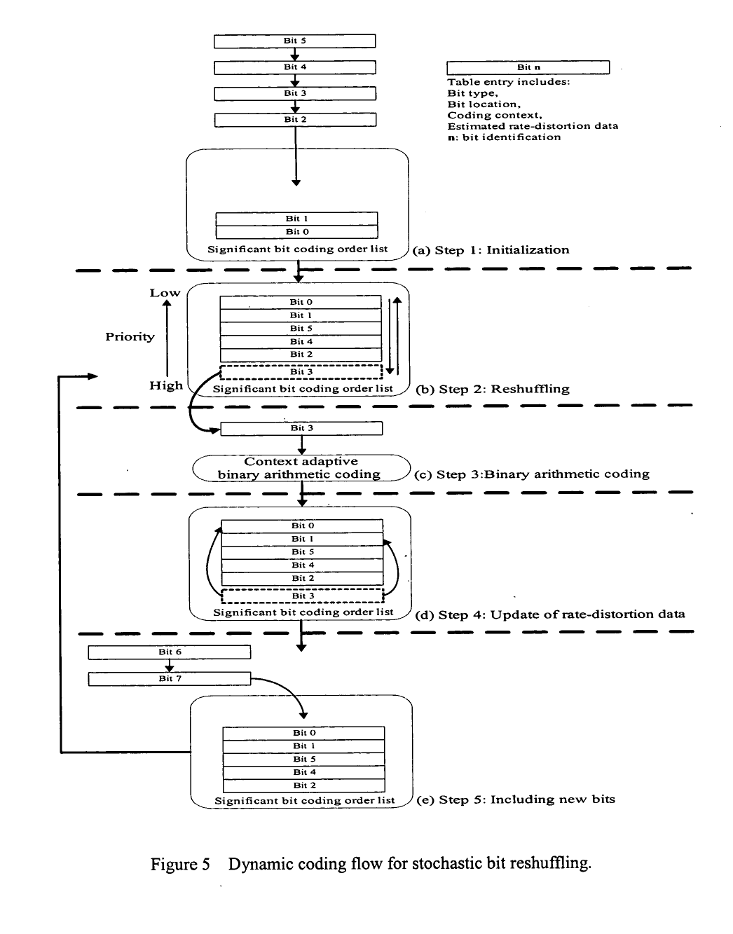

Given these constraints, FIG. 5 shows an overview of our coding flow. For simplicity, we only illustrate the significant bit list. The flow for the refinement bit is the same except that we do not need to update the rate-distortion data for refinement bit. In the beginning, the initialization step puts all the DC coefficient bits at the MSB bit-plane of an enhancement-layer frame in the list. Then, we reshuffle the bits in the list according to the estimated rate-distortion data. From the reshuffling result, we retrieve the highest priority bit and perform the binary arithmetic coding. After the coding, we update the associated context probability model. Since the context probability model is refined and the contexts of the co-located significant bits could be changed after the coding, we update the outdated rate-distortion data in the list. After update, we use a diffusion-like mechanism to include more bits for reshuffling. The steps (b) to (e) in FIG. 5 are repeated until all the input bits are coded.

TABLE 5
Link between current coded bit and the following ones to be included for reshuffling

| | Coded | |
|---|---|---|
| Bit Type | value | The following bits to be included in the coding list |
| Significant | 0 | The significant bit (part I) of the same coefficient at lower bit- |
| bit part I | | plane |
| | 1 | The refinement bit of the same coefficient at lower bit-plane |
| Significant | 0 | The significant bit (part I) of the same coefficient at lower bit- |
| bit part II | | plane |
| | | The significant bit (part II) of next zigzag coefficient (at the |
| | | same |
| | | bit-plane) |
| | 1 | The refinement bit of the same coefficient at lower bit-plane |
| | Not EOSP | The significant bit (part II) of next zigzag coefficient (at the |
| | | same bit-plane) |
| | 1 | The refinement bit of the same coefficient at lower bit-plane |
| | EOSP | The significant bit (part II) of next coefficient in zigzag order |
| | | (at the lower bit-plane) |
| Refinement | 0 or 1 | The refinement bit of the same coefficient at lower bit-plane |
| bit | | |

1. Update of Rate-Distortion Data

Updating the estimated rate-distortion data is to guarantee that we always use the latest context probability model for estimation. Particularly, we only update the rate-distortion data of significant bit. The ones of refinement bit are not updated because they are derived from estimated Laplacian probability model. The estimated Laplacian probability model is fixed throughout the reshuffling process.

In our algorithm, the significant bits in the list and to be updated are:
Category 1: The significant bits that use the same context as current coded one.
Category 2: The significant bits of co-located coefficients in the adjacent blocks.
Category 3: The part I significant bits after the current coded bit (in zigzag order).
   2. Including New Bits

Since not all input bits can be simultaneously put in the list for reshuffling, we proposed a diffusion-like scheme to include more bits for reshuffling and coding. The basic idea is to include the not yet coded bits around the coded ones first. Table 5 defines our mapping rules between the current coding bit and the following ones to be included.

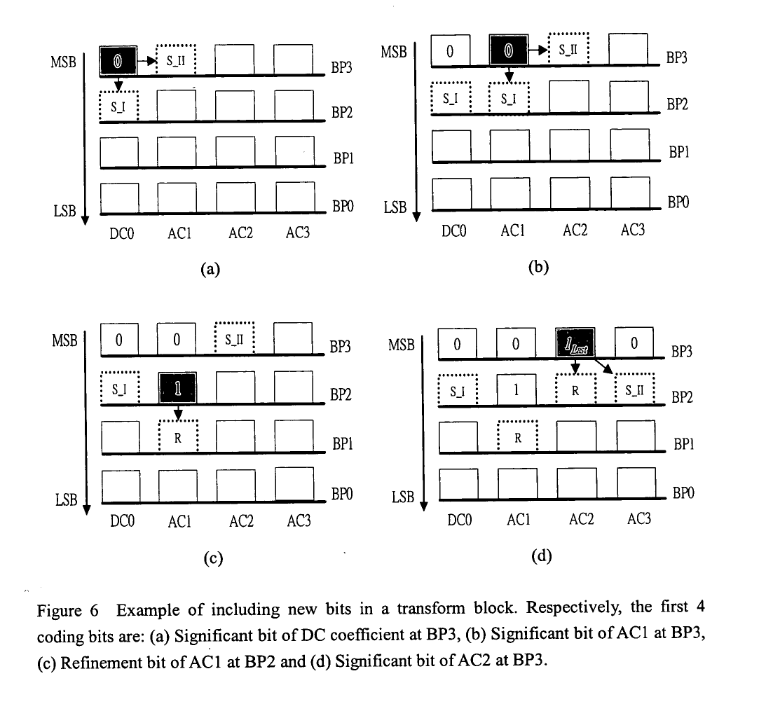

FIG. 6 shows an example. Sequentially, from FIG. 6 (a) to FIG. 6 (d), we show the first 4 coding states of a transform block. For simplicity, the transform block has only 4 coefficients. Each column denotes the binary representation of a coefficient and each row represents a bit-plane. From left to right, the coefficients are in zigzag order. For each coefficient, the blank rectangle means a not yet coded bit. On the other hand, the rectangle with a binary number shows the coded value. The shaded rectangle represents the current coding bit and the dash rectangle denotes the bits in the list. For those bits in the list, we use S_I, S_II or R to denote their bit type. S_I means significant bit of part I and S_II denotes significant bit of part II. On the other hand, R represents refinement bit.

FIG. 6 (a) shows that the bit of DC coefficient at BP3 is recognized as highest priority bit and coded as zero. After the coding, we include the significant bit of AC1 at BP3 and the significant bit of DC0 at BP2 in the list according to the 3^{rd} rule in Table 5. After the reshuffling, FIG. 6 (b) shows the case when the significant bit of ACI at BP3 is coded. Similarly, we include the significant bit of AC2 at BP3 and the significant bit of AC1 at BP2. After that, FIG. 6 (c) shows the case in which the significant bit of ACI at BP2 is coded prior to the significant bit of DC0 at BP2. By definition, the “Run” context for significant bit of AC1 depends on the significance status of DC0. However, we allow using non-actual context for coding as long as it has better estimated rate-distortion performance. According to the 1^{st} rule in Table 5, we include the refinement bit of AC1 at BP1 after the coding. Finally, FIG. 6 (d) shows the case when the MSB of AC2 is of highest priority and is recognized as EOSP of BP3. According to the 5th rule in Table 5, we include the refinement bit of AC2 at BP2 and the significant bit of AC3 at BP2 in the list. Following the rules in Table 5, one can complete the coding of all the other input bits.

H. Dynamic Memory Organization

Updating and reshuffling the significant bits requires intensive computation. To reduce the computations, we proposed a dynamic memory organization scheme to manage the registers in the significant bit list. We observe that not all the significant bits in the list are required for updating and reordering. Hence, our scheme simply reorders and updates those affected bits while keeping the others untouched.

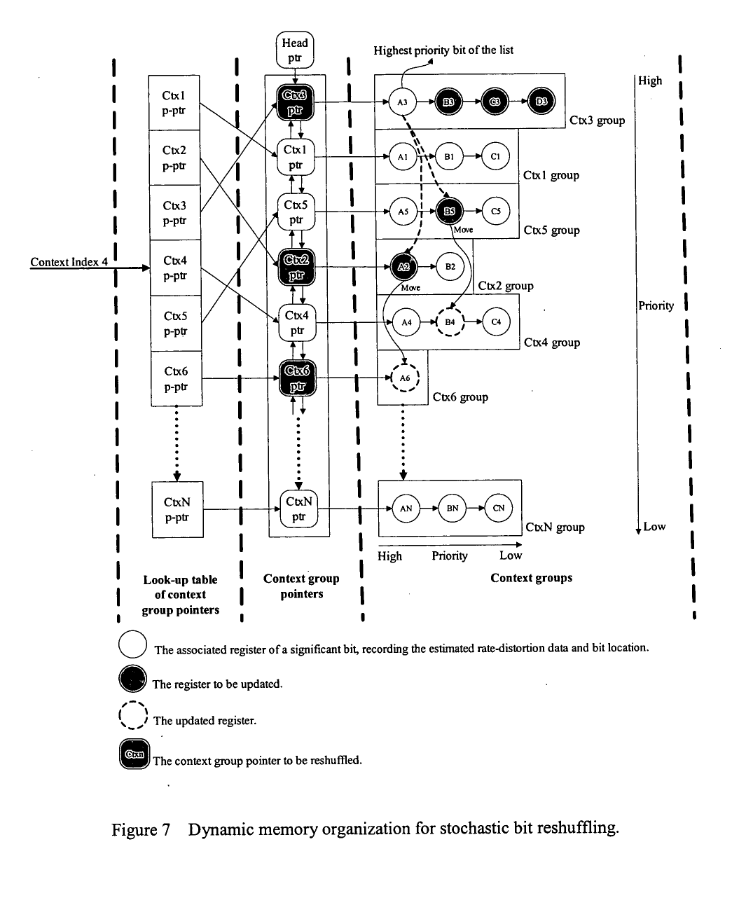

To quickly identify the significant bits that use the same contexts as current coded one, we group the significant bits with the same contexts using a link list. At the right hand side of FIG. 7, we show an example where each circle denotes the associated register of a significant bit and each rectangle represents a context group. By definition, the registers A3, B3, C3 and D3 have the same contexts. For identifying the highest priority bit of each group, we further reorder the registers in a group according to the ratio of Ê(ΔD)/Ê(ΔR). From left to right, the priority (i.e., the ratio of Ê(ΔD)/Ê(ΔR)) is in descending order.

With our grouping scheme, the highest priority bit of the list can be found by comparing the highest priority bit of each group. To perform such comparison, we assign each group a context group pointer that points to the highest priority bit in a group. By reordering the context group pointers according to the highest priority bit of each group, the highest priority bit of the list can be identified. Particularly, to maintain the order, we implement the context group pointers with a link list structure. In FIG. 7, the context group pointers are shown at the central part. From top to bottom, the priority is in descending order, i.e., we have A3>A1>A5>. . . >AN. In this example, A3 is not only the highest priority bit of Ctx3 group but also the highest priority one of the list.

After the highest priority bit is identified and coded, we need to update the significant bits whose contexts are changed. Since the coding is dynamic, we cannot determine in advance which significant bits are to be updated. As a result, whenever a non-zero significant bit is coded, we follow the definitions of category 2 and category 3 in previous section to derive the bit locations of those outdated significant bits. According to the derived bit locations, we recalculate their contexts before the coding by reversing the state of the coded bit. From the context index of the outdated bits, we can confine our search in those context groups. To avoid exhaustive searching in all the context group pointers we construct a look-up table that takes the context index as input and produces the associated context group pointer as output. The left hand side of FIG. 7 shows such a look-up table. Practically, the table is implemented as an array of pointers that point to the context group pointers.

For illustration of the overall updating and reordering flow, we use FIG. 7 as an example in which we assume the significant bits in each group and the context group pointers have been reordered since the initialization. Thus, in the actual coding, we simply modify and reorder parts of the registers whenever a significant bit is coded. In this example, A3 is the highest priority bit of the list. When A3 is coded, B3 and D3 are to be updated because they have the same context as the coded bit. In addition, in FIG. 7, we assume there are two significant bits whose contexts are changed after the coding of A3. Respectively, we assume the contexts for these two bits before the coding of A3 are Ctx5 and Ctx2. On the other hand, the corresponding contexts after the coding of A3 are assumed as Ctx4 and Ctx6. Since the contexts for these two significant bits are changed, we update the registers using the latest context probability models and move the associated registers from one group to the other group. The context indices before the coding identify the context groups to search the registers for update. On the other hand, the context indices after the coding determine the destination groups in which we should put the modified register. With all these context indices, we use the look-up table to quickly access the context groups for search and update. Note that the search within a group is done by comparing the bit location. As shown in FIG. 7, the register B5 are updated and moved from Ctx5 group to the B4 position of Ctx4 group. Similarly, the register A2 are updated and moved from Ctx2 group to the A6 position of Ctex6 group. Particularly, when a modified register is put in a destination group, its location in the link list is determined by the updated rate-distortion data. For instance, the register B5 is moved to B4 because the priority among them is A4>B4(B5)>C4. After the update and move, the highest priority bits of Ctx3 group, Ctx2 group, and Ctx6 group are changed. Thus, we re-determine the order of those groups in the link list of context group pointers. Specifically, we first remove those group pointers from the link list. Then, we sequentially insert them back at proper positions by comparing the updated highest priority bit. In such way, we can keep those unchanged context groups untouched. In our implementation, the link list of the context group pointers is implemented as bi-directional so that we can randomly and quickly remove any node from the list.

I. Experimental Results

1. Subjective Quality Comparison

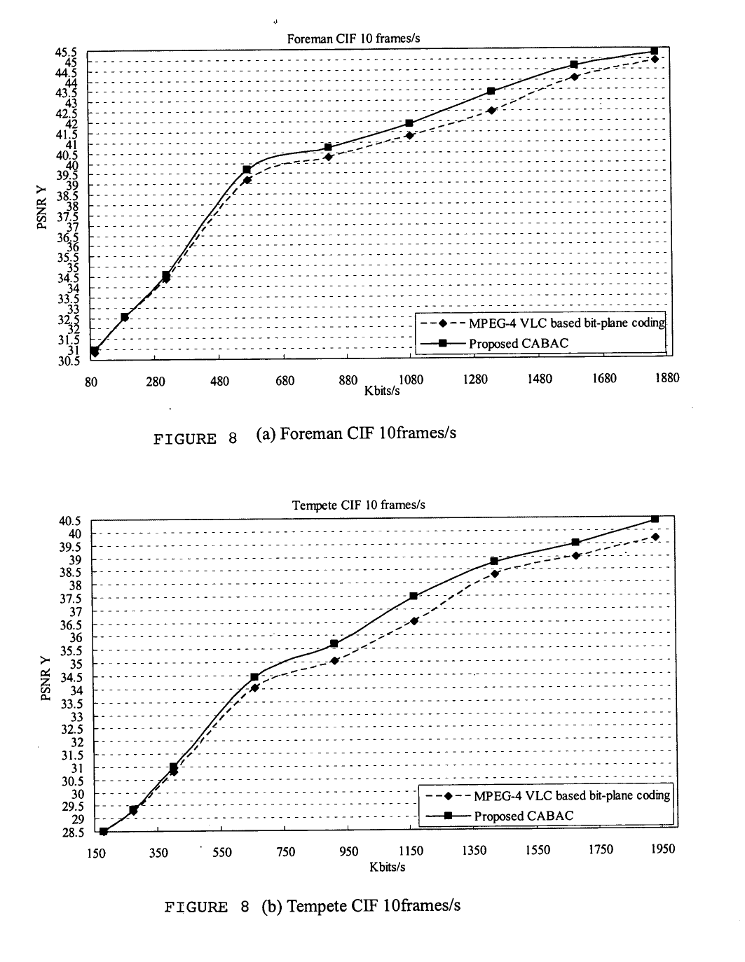

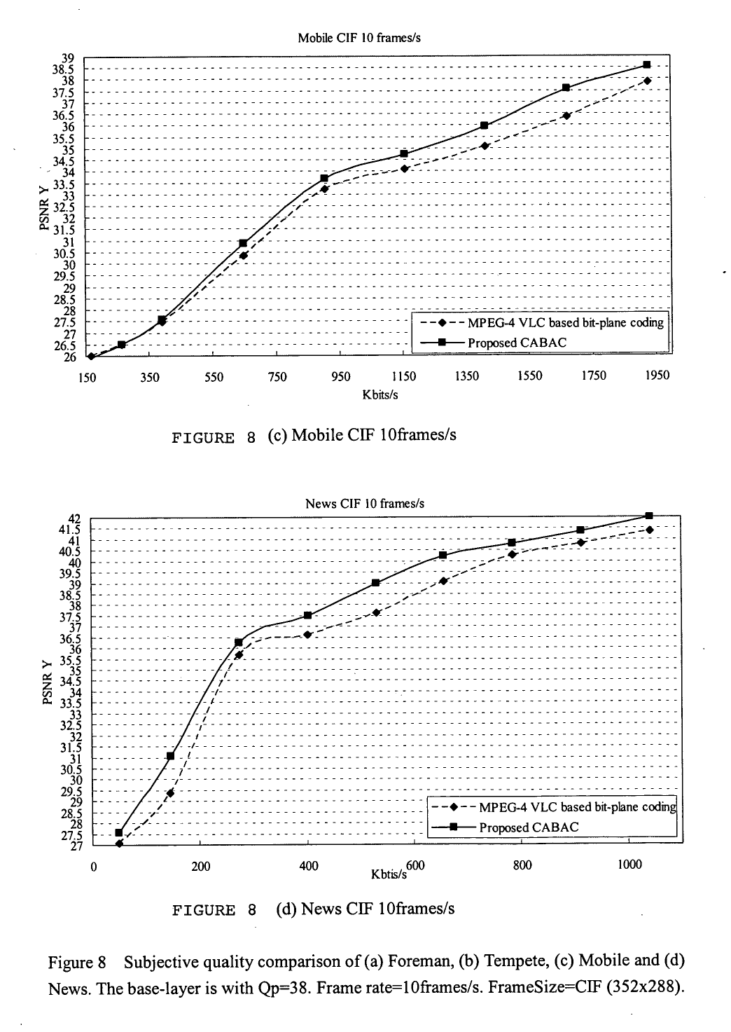

In our subjective quality comparison, we used H.264 JM4 as base-layer and RFGS as enhancement-layer. Specifically, we use PSNR as our subjective quality measurement. The baseline system uses MPEG-4 FGS based bit-plane coding with retrained table and follows identical testing conditions. FIG. 8 shows the PSNR comparisons. As shown, our algorithm averagely improves the PSNR over baseline system by 0.5˜1.5 dB.

2. Objective Quality Comparison

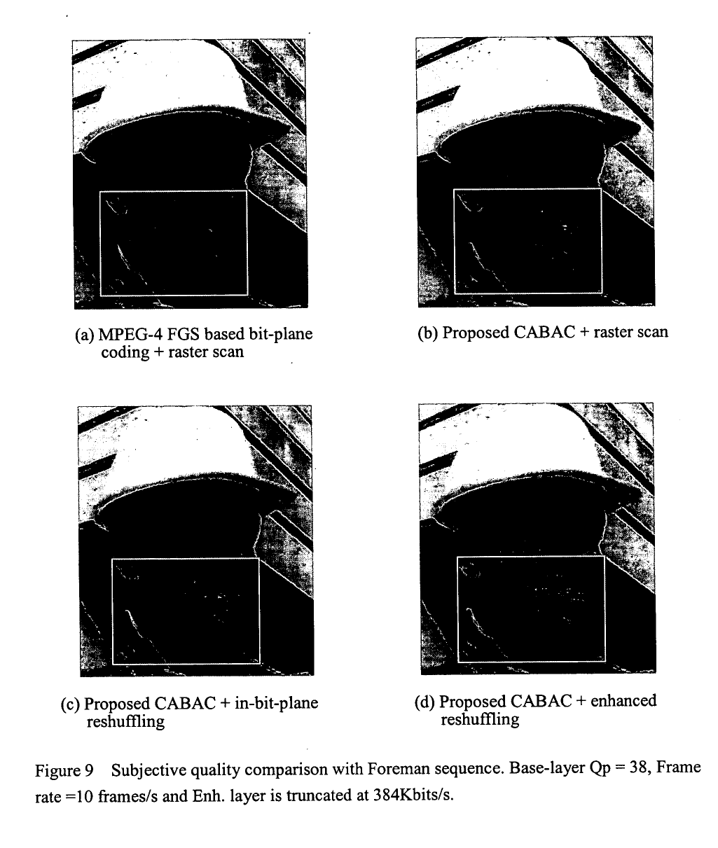

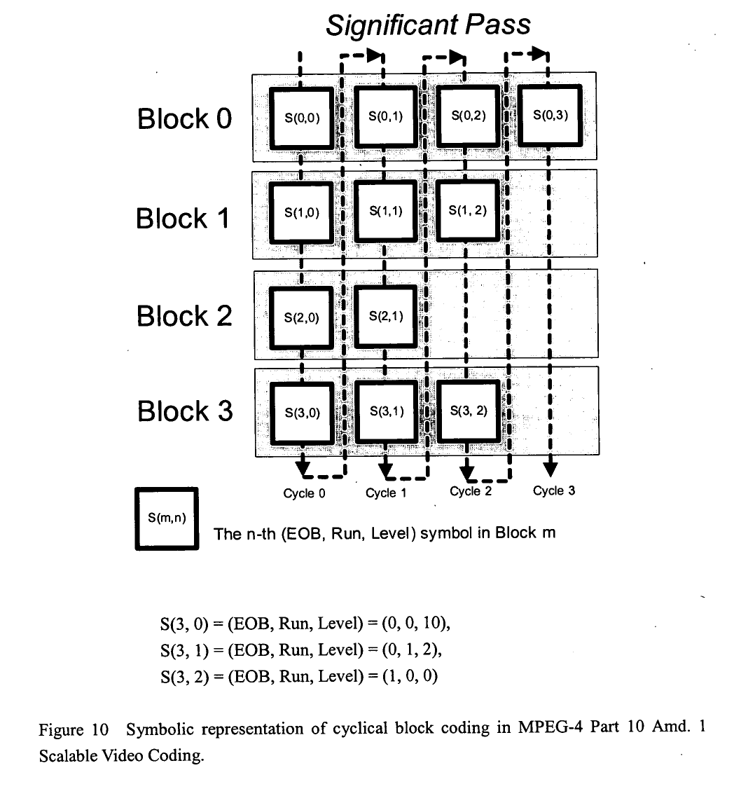

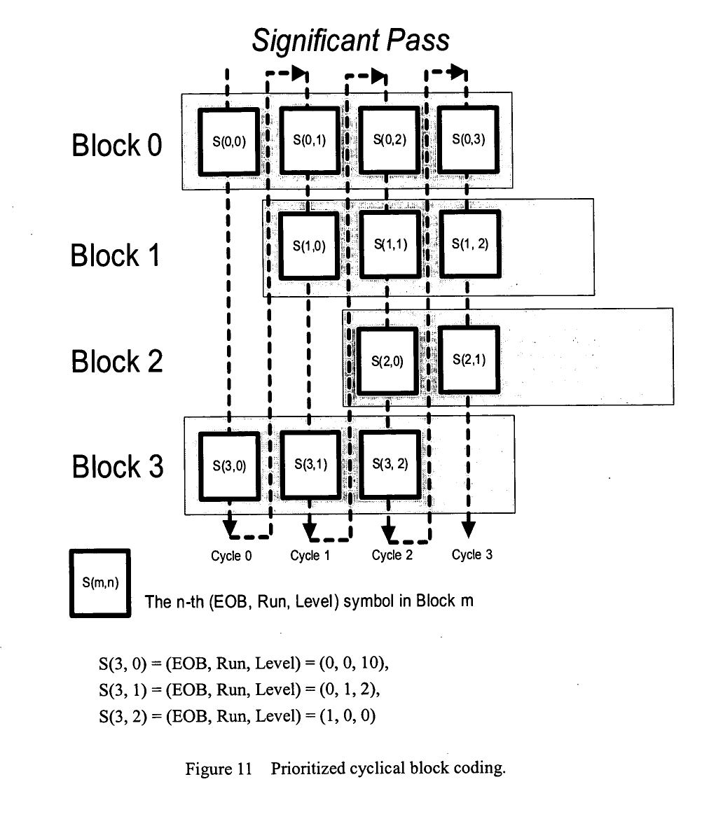

FIG. 9 shows the subjective quality comparison among different approaches. The approaches for comparison are: (a) MPEG-4 FGS based bit-plane coding with raster scan, (b) proposed CABAC with raster scan (c) proposed CABAC with in-bit-plane reshuffling [4] and (d) proposed CABAC with enhanced stochastic reshuffling scheme shown in this patent. As expected, FIG. 9 (a) and FIG. 9 (b) show that the deterministic raster-scan approaches have uneven quality distribution. The upper part offers smooth quality while the lower part shows obvious blocking artifact. In contrast, FIG. 9 (c) and FIG. 9 (d) show more even quality over the entire frame. Particularly, FIG. 9 (d) shows that the enhanced stochastic bit-reshuffling perform even better than the restricted in-bit-plane reshuffling in [4]. The experiment results of the other sequences also show similar performance.

J. Applications of Bit Reshuffling

The concept of bit reshuffling can be extended to the reshuffling at coefficient, block, region or cycle levels for various purposes such as rate-distortion optimization, subjective quality improvement, and region-of-interest functionality. The disclosed idea can adopt different priority assignments and perform reshuffling at different granularities for specific applications.

Here, we show an extension of disclosed bit reshuffling on the rate-distortion performance and the subjective quality improvement for the cyclical block coding of MPEG-4 Part 10 Amd. 1 Scalable Video Coding. FIG. 10 shows a symbolic representation of cyclical block coding in MPEG-4 Part 10 Amd. 1 Scalable Video Coding. As shown, each transform block is equally coded with a (EOB, Run, Level) or a refinement symbol in a coding cycle. Blocks with less non-zero coefficients are completed prior to the blocks having more non-zero coefficients. However, from the rate-distortion optimization perspective, blocks with more energy should be assigned with higher coding priority. The disclosed bit reshuffling scheme can be extended and applied for distinguishing the importance of different symbols, blocks or regions.

FIG. 11 shows an embodiment of prioritized cyclical block coding. As shown, different blocks may be unequally coded in a coding cycle. Particularly, to avoid transmitting the priority information (overhead), the encoder and the decoder can refer to the same context for block or symbol priority assignment just as the disclosed parameter estimation scheme for the bit reshuffling. In addition, the prioritized cyclical block coding can be used for region-of-interest functionality. Blocks in the region-of-interest can be coded with higher priority. Particularly, the priority information can be either embedded in the bitstream or implied by the context reference.

The invention discloses a novel context based binary arithmetic coding with a stochastic bit-reshuffling scheme to improve both the coding efficiency and the subjective quality of MPEG-4 FGS based bit-plane coding. The proposed scheme can be used not only in MPEG-4 FGS but also in other advanced FGS schemes such as Robust FGS (RFGS) H. C. Huang, C. N. Wang and T. Chiang, “A Robust Fine Granularity Scalability Using Trellis Based Predictive Leak,” IEEE Trans. on Circuits System for Video Technology, vol. 12, no. 6, pp. 372-385, June 2002, Progressive FGS (PFGS), F. Wu, S. Li, and Y Q. Zhang, “A Framework for Efficient Progressive Fine Granuality Scalabel Video Coding,”IEEE Trans. Circuits Syst. Video Technol., vol. 11, pp. 332-344, 2001, and so on. Moreover, the concept of stochastic bit reshuffling can be applied to other embedded entropy coding schemes.

Having described the preferred embodiments of the invention, however, it should be obvious to those who are skillful in the art that various changes and modifications can be made therein without departing from the spirit and scope of the present invention defined in the appended claims.

1. A method for performing context adaptive binary arithmetic coding with stochastic bit reshuffling for fine granularity scalability, comprising steps of:
replacing 8×8 DCT with 4×4 integer transform coefficient in MPEG-4 AVC;
partitioning each transform coefficient into significant bit and refinement bit;
setting up significant bit context based on energy distribution within a transform block and spatial correlation in adjacent blocks;
using an estimated Laplacian distribution to derive coding probability for the refinement bit; and
using the context across bit-planes to partition each significant bit-plane for saving side information bit.

2. The method according to claim 1, wherein the step of using the context across bit-planes to partition each significant bit-plane for saving side information bit includes using EOSP location of higher bit-plane to partition each significant bit-plane into two parts for saving side information bit.

3. The method according to claim 1, further comprising determining coding order of each bit by its estimated rate-distortion, wherein all the coding bit are ordered in a descending ordering in accordance with a ratio of estimated distortion reduction over estimated bit rate.

4. The method according to claim 3, wherein the estimated rate-distortion for each bit is obtained by using discrete Laplacian distribution to model the transform coefficient.

5. The method according to claim 1, further comprising using binary entropy for coding bit rate estimation, and using maximum likelihood principle to provide an estimation for parameters of the Laplacian distribution.

6. The method according to claim 1, further comprising using a dynamic coding flow for the stochastic bit reshuffling.

7. The method according to claim 8, wherein the bit reshuffling can be extended to the reshuffling at coefficient, block, region or cycle levels for various purposes such as rate-distortion optimization, subjective quality improvement, and region-of-interest functionality.

8. The method according to claim 1, further comprising using different priority assignments and perform reshuffling at different granularities for specific applications.

9. The method according to claim 3, further comprising using binary entropy for coding bit rate estimation, and using maximum likelihood principle to provide an estimation for parameters of the Laplacian distribution.
